(19) United States
(12) Patent Application Publication
(10) Pub. No.: US 2021/0039573 A1
(43) Pub. Date: Feb. 11, 2021

(54) Safe protection equipment for all vehicles and drivers

(71) Applicant: Qiusheng Gao, Cupertino, CA (US)

(72) Inventor: Qiushengng Gao, Wujiang (CN)

(21) Appl. No.: 16/536,331

(22) Filed: Aug. 9, 2019

(51) Int. Cl. B60R 19/18; B60R 19/42

(52) U.S. Cl. CPC B60R 19/18; B60R 2019/1833; B60R 19/42

(57) ABSTRACT

Safe protection equipment for all vehicles will significantly reduce the collision force by elasticity of material and strength of object with elliptical arch or dome shape, high stiff and tensile strength in that the stretchy materials will be compressed to absorb the energy and reduce the colliding force that is passed to and spread over to the object with strong strength when the vehicle hit an obstacle or two vehicles collide with each other. The reduced colliding force that is spread over a big area instead of focusing on a small spot will be passed to the frame or body of the vehicle with much less damage to the body of the vehicle and the passengers in the vehicle significantly.

This equipment will protect both vehicles and drivers without changing the current air-bag protection system. It will significantly reduce the damage for serious collision accidents.

This safe equipment can be installed on front, rear, side or corner of the vehicle to replace the bumper or cover of the vehicle door or body. Some vehicles might need to change the cover or frame design to attach the equipment properly.

### TECHNICAL FIELD

The present invention generally relates to improvements in protecting both vehicles and drivers over collision accidents utilizing the elasticity of material and strength of object with elliptical arch or dome shape, stiff and tensile material from either front, rear, side and/or corner. The safe equipment is composed of two layers of different material. The outer layer is made of the regular steel or aluminum alloy current used in the bumper or cover of the car door or body. The internal layer is made of material with high stiffness and tensile strength. The elliptical arch or dome shape gives strong strength to the internal layer. The space between two layers are filled with a mat of stretchy material, a mattress of springs, or a rub mat with small pillars. When the vehicle hits an obstacle or collides with each other, the out layer will be deformed and push the stretchy material, rub mat or spring mattress that will be deformed and compressed to absorb the energy and reduce the colliding force. The reduced colliding force will be passed to and spread over the internal layer, which will pass the reduced colliding force more smoothly to where the internal layer stays. In this way, the damage to the vehicles and the passengers inside the vehicles will be significantly reduced.

There is no change for the current airbag protection system.

### BACKGROUND ART

Currently, most vehicles use airbag to protect the drivers in collision accidents. There is limitation with airbag protection. Airbag only protects driver, but not vehicle. When the vehicle hits an obstacle or collide with each other, the vehicle body and auto parts can be damaged. In case of heavy collision accident, not only the vehicles are seriously damaged, but also the drivers could be seriously injured or even killed due to the strong colliding force. Even in case the collision is not heavy, the vehicle body or auto parts are still damaged.

### SUMMARY OF THE INVENTION

An object of the present invention is to utilize the elasticity of springs, rubber mat with rub pillars and stretchy material to absorb the energy and reduce the colliding force. The reduced colliding force is spread over a sheet of material with high stiff and tensile strength, elliptical arch or dome shape. Eventually the reduced colliding force is passed to the car body more smoothly. The current airbag protection system is not changed. Overall it will significantly reduce the damage for both vehicles and drivers in the collision accidents in that the colliding force is only reduced by the deformation of the bumper or the cover of the car door or body.

In accordance with the present invention, there are two layers of different material. The outer layer is made of the regular steel or aluminum alloy currently used in the bumper or the cover of the car door or bumper. The internal layer is made of material with high stiffness and tensile strength, elliptical arch or dome shape that makes the internal layer hard to be deformed so the colliding force will be spread over the whole internal layer more smoothly instead of focusing on a small spot area sharply. The space between two layers are filled with a mat of stretchy material, a mattress of springs, or a rub mat with small pillars.

In accordance with the present invention, when the vehicle hits an obstacle or collides with each other, the out layer will be deformed to absorb energy. The outer layer will also push the stretchy material, rub mat or spring mattress that will be deformed and compressed to absorb the energy and reduce the colliding force. The reduced colliding force will be passed to and spread over the internal layer, which will pass the reduced colliding force more smoothly to where the internal layer stays. In this way, the damage to the vehicle and the passengers inside the vehicle will be significantly reduced.

In accordance with the present invention, this safe equipment can be installed on front, rear, side or corner of the vehicle to replace the bumper or cover of the vehicle door or body. Some vehicles might need to change the cover or frame design to attach the equipment properly.

### BRIEF DESCRIPTION OF THE DRAWINGS

There are five figures in the attached drawings.

FIG. 1 provides the cross section view of the safe equipment with a mat of stretchy material filled between two layers.

FIG. 2 provides the cross section view of the safe equipment with a mattress of springs filled between two layers.

FIG. 3 provides the cross section view of the safe equipment with a rubber mat and rub pillars filled between two layers.

FIG. 4 provides the 3-D view of the safe equipment that has elliptical arch shape.

FIG. 5 provides the 3-D view of the safe equipment that has elliptical dome shape.

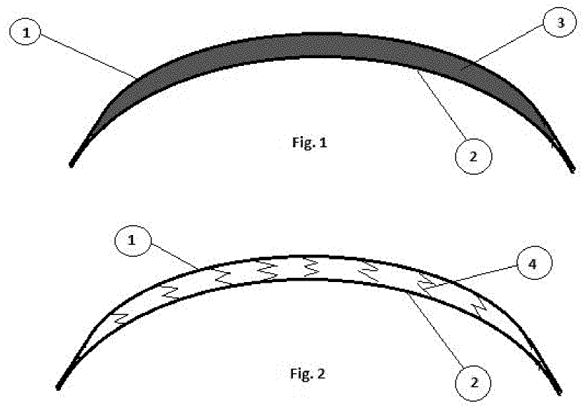

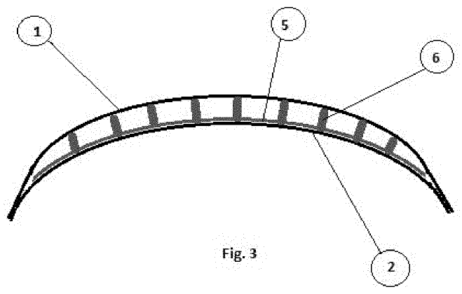

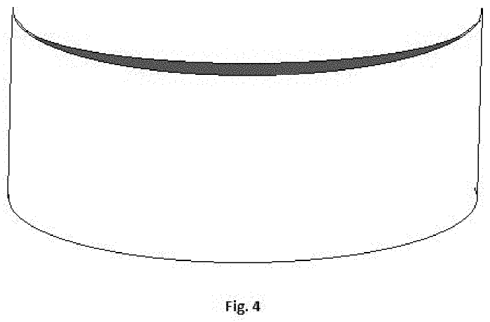

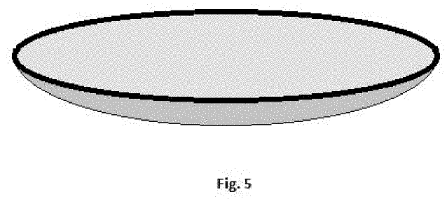

Following are the detailed information about the primary components of the equipment.

1. Outer layer of the safe equipment. Outer layer has the similar shape to internal layer and the space between two layers has the longest distance in the middle of the elliptical arch or top of the elliptical dome. The material of the outer layer is the regular steel or aluminum alloy currently used for the cover of the car door or body.

2. Internal layer of the equipment with the shape of elliptical arch or dome. The material of the internal layer has the high stiffness and tensile strength.

3. A mat of stretchy material filled between two layers.

4. A mattress of springs filled between two layers.

5. A mat of rubber.

6. Rubber pillars attached to the rubber mat.

### DETAILED DESCRIPTION OF PREFERRED EMBODIMENTS

This equipment can be applied to all type of vehicles, e.g., cars, vans and trucks. The outer layer (1) has similar shape to the internal layer (2) and the space between two layers has the longest distance in the middle of the elliptical arch or top of the elliptical dome. The material of outer layer (1) is the regular steel or aluminum alloy currently used for the cover of the car door or body. The internal layer (2) has the shape of elliptical arch or dome. The material of internal layer (2) has high stiffness and tensile strength and is hard to be deformed. The outer and internal layer is strongly glued or wielded or put together by screws near the side. The space between outer layer (1) and internal layer (2) is filled by a mat of stretchy material (3), or a mattress of springs (4), or a rubber mat (5) with rubber pillars (6). The equipment can be installed on front, rear, side or corner of the vehicle to replace the bumper or cover of the car door or body. Some vehicles might need to change or enhance the frame design to attach the equipment properly.

When the vehicle hit an obstacle or two vehicles collide with each other in straight line or the side of the car door is hit, the outer layer (1) will be deformed to absorb the energy. The outer layer (1) will push the mat of stretchy material (3), or the mattress of springs (4), or the rubber pillars (6) and rubber mat (5), which will be deformed and compressed to absorb the energy and reduce the colliding force. The reduced colliding force is passed to and spread over the whole internal layer (2) instead of focusing on a small spot because the internal layer (2) is hard to be deformed. Eventually the internal layer (2) will pass the reduced colliding force more smoothly to where the internal layer stays. If the colliding is very heavy, it will also trigger the vehicle to pop up the airbag. In any case, the damage of the vehicle and the driver from the collision accidents will be reduced significantly, comparing with the current vehicle in a collision that energy is only absorbed by the deformation of the bumper or cover of the body or door without the safe equipment.

1. Safe equipment comprising:
outer layer (1)
internal layer (2) with high stiffness and tensile strength and elliptical arch or dome shape a mat of stretchy material (3) filled in the space between outer layer (1) and internal layer (2) characterized in that a colliding force hitting on the outer layer (1) and pushing the mat of stretchy material (3) thereof the outer layer (1) will be deformed and the mat of stretchy material will be compressed to absorb the energy and reduce the colliding force that is passed to and spread over the internal layer (2) that will further pass the reduced colliding force to where the internal layer (2) stays smoothly hence significantly reduce the damage to the body of the vehicle and the passengers inside the vehicle in that the colliding force hitting on a bumper or the cover of vehicle door or body is only reduced by the deformation of the bumper or the cover of the vehicle door or body without the safe equipment.

2. The safe equipment as claimed in claim 1 with the mat of stretchy material (3) replaced by a mattress of springs (4) characterized in that a colliding force hitting on the outer layer (1) and pushing the mattress of springs (4) thereof the outer layer (1) will be deformed and the mattress of springs (4) will be compressed to absorb the energy and reduce the colliding force that is passed to and spread over the internal layer (2) that will further pass the reduced colliding force to where the internal layer (2) stays smoothly hence significantly reduce the damage to the body of the vehicle and the passengers inside the vehicle in that the colliding force hitting on a bumper or the cover of vehicle door or body is only reduced by the deformation of the bumper or the cover of the vehicle door or body without the safe equipment.

3. The safe equipment as claimed in claim 1 with the mat of stretchy material (3) replaced by a rubber mat (5) with rubber pillars (6) characterized in that a colliding force hitting on the outer layer (1) and pushing the rubber pillars (6) and mat (5) thereof the outer layer (1) will be deformed and the rubber mat (5) with rub pillars (6) will be deformed and compressed to absorb the energy and reduce the colliding force that is passed to and spread over the internal layer (2) that will further pass the reduced colliding force to where the internal layer (2) stays smoothly hence significantly reduce the damage to the body of the vehicle and the passengers inside the vehicle in that the colliding force hitting on a bumper or the cover of vehicle door or body is only reduced by the deformation of the bumper or the cover of the vehicle door or body without the safe equipment.

4. The safe equipment as claimed in claims 1 and 2 and 3 characterized in that the safe equipment can be applied to front and/or rear and/or side and/or corner of a vehicle.
